(19) United States
(12) Patent Application Publication
(10) Pub. No.: US 2022/0126577 A1
(43) Pub. Date: Apr. 28, 2022

(54) MOLDED STRUCTURES WITH CHANNELS

(71) Applicant: Hewlett-Packard Development Company, L.P., Spring, TX (US)

(72) Inventors: Chien-Hua Chen, Corvallis, OR (US); Michael W. Cumbie, Corvallis, OR (US); Michael G. Groh, Corvallis, OR (US)

(73) Assignee: Hewlett-Packard Development Company, L.P., Spring, TX (US)

(21) Appl. No.: 17/312,743

(22) PCT Filed: Jun. 25, 2019
(86) PCT No.: PCT/US2019/039078

§ 371 Date: Jun. 10, 2021

(51) Int. Cl. B41J 2/14; B41J 2/16

(52) U.S. Cl. CPC B41J 2/14145; B41J 2/14024; B41J 2/14072; B41J 2/1603; B41J 2/1623; B41J 2202/12; B41J 2/1632; B41J 2/1639; B41J 2/1643; B41J 2202/11; B41J 2/1626

(57) ABSTRACT

An example fluidic device may comprise a fluidic die, a unitary molded structure, and a fluidic fan-out structure—The unitary molded structure may comprise thermo-electric traces and fluidic channels and may be coupled to the fluidic die. A first dimension of the fluidic channels is between ten μm to two hundred μm, or less. The fluidic fan-out structure may also be coupled to the molded structure. The fluidic die, the molded structure, and the fluidic fan-out structure may be arranged such that a first fluidic channel of the fluidic channels is in fluid communication with an aperture of the fluidic die at a first extremity and to a fluidic fan-out fluid channel through hole of the fluidic fan-out structure at a second extremity.

### BACKGROUND

At times, devices, such as semiconductor devices, may be attached to molded structures. The molded structure may have through holes or channels through which fluids and gasses (among other things) may travel. A number of processes exist for creating molded structures with through holes or channels. For instance, build up processes, such as lithography on dry film, may be used to create molded structures with through holes or channels. Substrate bonding and/or welding may also be used to yield molded structures with through holes or channels.

### BRIEF DESCRIPTION OF THE DRAWINGS

Various examples will be described below by referring to the following figures.

FIGS. 1A and 1B are illustrations of example devices comprising a molded structure with channels;

FIG. 2 is an illustration of an example device having a molded structure with channels;

FIGS. 3A and 3B show an example device comprising a molded structure with channels and a fluidic die with recirculation channels;

FIG. 4A-4E show an example molded structure from a number of perspectives;

FIG. 5 is a flow chart illustrating an example method of forming a molded structure with channels;

FIGS. 6A-8D show cross sections of an example molded structure illustrating various points in its fabrication;

FIG. 7 is a flow chart illustrating an example method of forming a molded structure; and

FIGS. 8A-8G show cross sections of an example molded structure at various points in its fabrication.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration.

### DETAILED DESCRIPTION

In the context of fluidic devices, such as printing fluid ejection devices, portions of the devices may be attached to supporting components. The supporting components may provide fluidic channels to enable printing fluid to flow to fluidic ejection dies of the fluidic ejection devices. In some cases, the supporting components may be made up of molding compounds and structures (referred to herein as molded devices or molded structures).

In addition to receiving fluids from supporting components, the fluidic ejection dies may receive electric signals from other components of the printing fluid ejection devices. For example, electric signals, such as in the form of current pulses, for controlling ejection of printing fluids may be transmitted to the fluidic ejection dies via wires or traces that enable an electrical connection between the fluidic dies and a controller of the printing fluid ejection devices.

Further, in some implementations, thermal energy, such as in the form of heat, may be directed away from the fluidic ejection dies via thermally-conductive components and/or fluids. For instance, the fluidic ejection dies may use the application of heat to small volumes of printing fluid to generate bubbles of gas and expulse controlled droplets of printing fluid. The application of heat, such as by pulses of current through a resistive element, may, in some cases, cause thermal energy to build in the fluidic ejection die. Thermally conductive components may therefore be used to carry the generated thermal energy away from the fluidic ejection dies.

At times, the components that enable propagation of both electric signals and thermal energy may have similar characteristics, such as being metals or metalloids. Therefore, for simplicity, the present description refers to electrically and/or thermally conductive components as thermo-electric or thermo-electrically conductive traces.

In some cases, in addition to embedded thermo-electrical traces, the molded components may include channels, slots, and/or through holes. Channels refer to voids within a molded component through which fluids, gasses, electromagnetic radiation (EMR) (e.g., visible light), and the like may propagate. Through holes refer to channels that have independent openings at one (or more) surfaces of a molded supporting structure, and through which fluids may flow. Slots refer channels through that have an opening at one surface of the molded supporting structure, but not necessarily two. For instance, a slot may lead to a fluid channel, which may lead to another slot and/or a through hole. For simplicity, the present disclosure uses the term “channel” in a general sense, which may also refer to a through hole or a slot, according to context.

To illustrate how one such example molded device with fluid channels may be used in conjunction with a fluidic die, the example of an inkjet printing device (e.g., for dispensing printing fluids, such as colorants or agents, by way of example) is discussed without limitation. To be clear, while the concepts of molded devices with channels may apply to an inkjet printing device, it should be appreciated that they may be relevant to other contexts, such as to microfluidic devices for biomedical applications, optical propagation devices such as for sensing or transmitting EMR, and gas sensing devices, by way of example.

Thus, for an example inkjet printing device, a fluid ejection device (e.g., a printhead) may be used to dispense printing fluids (e.g., inks, colorants, agents) on a substrate. The fluid ejection device may include a fluidic die having an array of fluid ejection nozzles through which droplets of printing fluid are ejected towards a substrate. The fluidic die may be attached to a molded device (e.g., a chiclet) with channels, through which the printing fluid may flow, such as towards and/or away from the fluidic die. As such, the molded device may operate in conjunction with the fluidic die to enable ejection of printing fluids, such as by delivering fluids to the fluidic die, recirculating fluids (e.g., to reduce pigment buildup), providing thermal protection to the fluidic die (e.g., pulling heat away from the fluidic die, such as in cases in which the fluidic die ejects fluids in response to current pulses through resistive elements to generate heat), by way of example.

Looking at another illustrative example, in the space of microfluidics, a microfluidic die (e.g., a fluidic die) may be attached to a supporting component made up of a molding compound and having channels. In this case, the channels may be used to direct fluids and solids (e.g., blood, plasma, etc.) towards desired portions of the microfluidic die.

In these and other cases, there may be a desire to reduce device size. For example, smaller biomedical devices may be desirable, such as to enable inclusion of multiple testing apparatuses on a small die. Smaller devices may also enable biomedical testing using smaller fluidic volumes. And smaller devices may also reduce overall cost, such as by enabling a greater number of dies to be produced from a wafer. Of course, there may be a number of other reasons to seek to decrease a size of a fluidic device.

One aspect of the push to reduce fluidic device size may be reducing channel size within molded components. For instance, while it may be possible to use semiconductor fabrication processes to achieve node sizes on the order of 20 nm (and less), achieving corresponding sizes for channels within molded compounds may present complexity and challenges using traditional build-up fabrication and/or machining processes. In fact, even at the range of tens or hundreds of μm, forming channels in molded components may be challenging and/or expensive. For example, it may not be currently possible to machine channels within a molded component on the order of five μm to five hundred μm.

And returning to the example of an inkjet ejection device, there may be a desire to increase a fluid ejection nozzle density. But it may be that fluidic channel sizes within a molded component connected to a fluidic die may limit possible nozzle densities. There may be a desire, for instance, to have fluidic channels within a molded component on the order of five μm to five hundred μm, by way of example.

With the foregoing in mind, the present description proposes a process capable of yielding devices and components having channels on the order of tens to hundreds of μm.

In one implementation, for example, such channel sizes may be achieved by using a sacrificial material on or over which a molding material is deposited. The sacrificial material may then be removed (e.g., etched away) to leave channels of the desired dimensions within the molded structure. Thus, for example, channels on the order of tens to hundreds of μm may be formed within a molded component. In some cases, it may be possible to achieve channels of less than ten μm using a sacrificial material.

In some cases, this approach for creating channels within a molded component may also allow creation of other structures within the molded component. For instance, embedded traces of sacrificial material may be used in addition to thermo-electric traces and both may be encapsulated within a molding compound. The sacrificial material may be removed (e.g., etched away) while leaving the thermo-electric traces (e.g., by protecting the thermo-electric traces using a layer of photoresist while removing the sacrificial material). Thus, the resulting molded device may be suitable for propagation of fluidics (through the channels) and thermal energy and/or electrical signals (through the electrical traces; in some cases, the thermal energy may propagate through channels, as well).

As shall be apparent, such an approach may be desirable for yielding molding components with channels having desired dimensions.

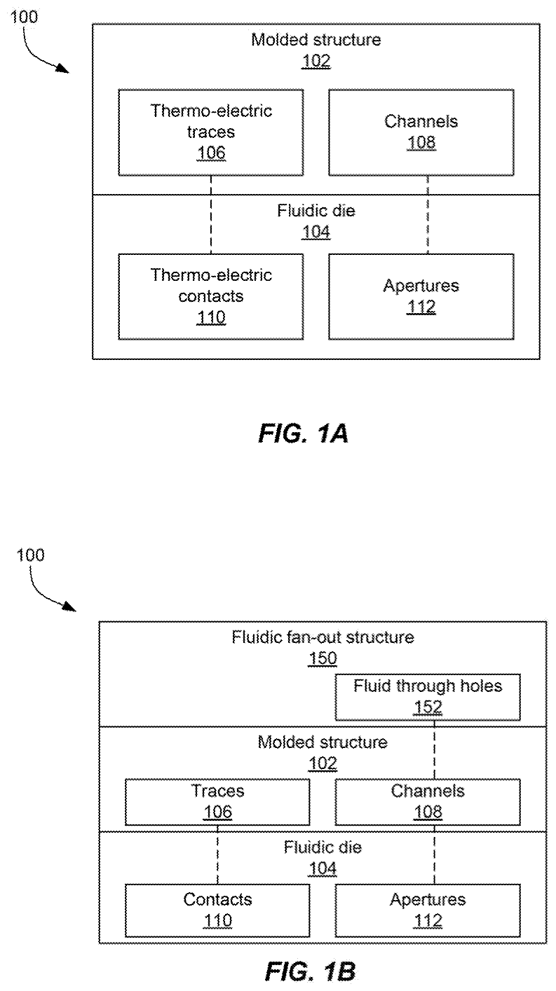

FIG. 1A illustrates an example device 100 that may include a molded structure 102 with channels 108 of between ten μm and two hundred μm, or smaller, by way of example. The process for yielding channels of such dimensions will be discussed further hereinafter, and it will be apparent that molded devices of other dimensions (e.g., less than ten μm, greater than two hundred μm, etc.) are contemplated by the present description and claimed subject matter (unless explicitly disclaimed).

FIG. 1A also illustrates an example fluidic die 104, attached to molded structure 102. In one example, molded structure 102 enables ejection of printing fluid by carrying printing fluids to and/or from fluidic die 104 via channels 108 and apertures 112. For example, apertures may correspond to fluid feed slots, which carry fluids towards and/or away from ejection chambers of the fluidic die. Further, the molded chiclet may also, in some cases, carry thermo-electric signals (e.g., via electrical traces 106 and electrical contacts 110 and/or via channels 108), such as to enable activation of ejection devices (e.g., resistors in the case of a thermal inkjet device, or piezo-membranes in the case of a piezoelectric inkjet device, etc.) and/or to carry thermal energy away from the ejection chambers of the fluidic die. By way of illustration of using channels 108 to dissipate thermal energy, fluids may flow through channels 108, the fluids may pull thermal energy away from one portion of fluidic die to a second portion of fluidic die.

In the context of a biomedical microfluidic device, fluidic die 104 may correspond to a microfluidic die, and molded structure 102 may correspond to a molded support component through which fluids may flow to and/or from the microfluidic die. Similar to the case of the fluidic die for ejection of printing fluids, the molded device in this example may enable operation of the biomedical microfluidic die due in part to the channels (e.g., channels 108) within molded structure 102. It will be appreciated that such fluidic dies may be used in a number of other cases, such as molded devices supporting chips with light emitting diodes (LEDs) and through which electrical signals and/or EMR may propagate; molded devices supporting sensor devices through which electrical signals, gasses and/or liquids may propagate for sensing by the sensor devices, etc.

Molded structure 102 may be composed of materials having a low coefficient of thermal expansion (low CTE). Example materials include (but are not limited to) epoxy molding compounds (EMC) and thermoplastic materials (e.g., polyphenylene sulfide (PPS), polyethylene (PE), polyethylene terephthalate (PET), polysulfones (PSU), liquid-crystal polymer (LCP), etc.). In one implementation, molded structure 102 may comprise a material (such as one of the foregoing) having a low CTE, such as in the range of 20 ppm/C or less. For instance, in one case, a material (such as one of the foregoing) may be selected having a low CTE, such as a CTE of 12 ppm/C or less.

As shall be discussed in further detail hereinafter, the material of molded structure 102 may be applied on or over a structure having sacrificial materials and/or thermo-electric traces. For example, sacrificial materials may be in the form of traces of a desired material (e.g., copper (Cu), nickel (Ni), etc.). In one case, for example, sacrificial structures may be applied to a support structure. In another case, a lead frame structure having portions with sacrificial materials may be used. A molding compound may then be applied on or over the structure.

Molded structure 102 may be unitary in form. As used herein, a unitary structure refers to a component that cannot be broken into parts without breaking an adhesive bond, cutting a material, or otherwise destroying that component. For example, an EMC may be used to form a unitary molded structure 102 having thermo-electric traces 106 and channels 108 formed therein as part of a molding process.

Returning to FIG. 1A, example molded structure 102 may be connected to example fluidic die 104 as illustrated. For instance, molded structure 102 may include thermo-electric traces 106 in communication with contacts 110 (e.g., electrical contacts) of fluidic die 104 (as illustrated by a broken line). Similarly, channels 108 may be in communication with apertures 112 of fluidic die (as illustrated by a broken line).

As noted, in one implementation, both thermo-electric traces 106 and channels 108 may be embedded within molded structure 102. However, in other cases, channels 108 may be embedded within molded structure 102 while thermo-electric contacts 110 may be in communication with thermo-electric traces external to molded structure 102 (not shown).

Furthermore, as noted above, in some implementations, thermo-electric traces 106 may correspond to electrically and/or thermally conductive traces that may be used for purposes other than carrying signals to thermo-electric contacts 110. For example, traces 106 may be capable of dissipating thermal energy away from fluidic die 104.

Because channels 108 may be formed within molded structure 102 using a sacrificial material that is subsequently removed, channels 108 may be between ten μm and two hundred μm, or less, in one dimension.

With the foregoing in mind, whether molded structure 102 is used in conjunction with a fluidic die for ejecting printing fluid or something else, as noted above, there may be a desire to have channels having a dimension of between ten μm and two hundred μm, or less. Such channel dimensions may be beneficial, such as by allowing apertures 112 of fluidic die 104 to be more densely arranged within fluidic die 104, such as than might otherwise be the case.

Thus, an example device (e.g., device 100) may comprise a molded structure (e.g., molded structure 102) connected to a fluidic die (e.g., fluidic die 104). The molded structure may comprise thermo-electric traces (e.g., thermo-electric traces 106) and channels (e.g., channels 108). The channels are to be between ten μm and two hundred μm, or less, in one dimension. The fluidic die may comprise apertures (e.g., apertures 112) corresponding to the channels and through which fluids, electromagnetic radiation, or a combination thereof is to travel. The fluidic die may also comprise contacts (e.g., electrical contacts 110) corresponding to the thermo-electrical traces of the molded structure. As noted above, the fluidic die may include a fluid ejection die, such as to eject printing fluid via ejection nozzles.

FIG. 1B illustrates another example device 100, this time with a fluidic fan-out structure 150 attached to molded structure 102. Fluidic fan-out structure 150 may include fan-out fluid through holes 152. Fan-out fluid through holes 152 may be capable of carrying fluid to and/or from molded structure 102, which may send the fluids on to fluidic die 104.

To illustrate with the example of a printing fluid ejection device, printing fluid may be caused to flow toward fluidic die 104 (for ejection onto a substrate) through fluid through holes 152 of fluidic fan-out structure 150, channels 108 of molded structure 102, and through apertures 112 of fluidic die. In some cases, printing fluid may flow away from fluidic die 104 (such as to recirculate the printing fluid to keep colorants of the printing fluid mixed) through apertures 112, channels 108, and back out fluid through holes 152.

Example device 100 may also be used for thermal control and dissipation, as noted above. For instance, fluidic die 104 may comprise a semiconductor device that may generate thermal energy (e.g., heat) through normal operation (e.g., as electrical current travels through traces and components of the semiconductor device). Fluidic die 104 may have microfluidic channels within its structure through which fluid may flow in order to remove thermal energy from the device. The thermal energy dissipating fluid may enter and leave fluidic die 104 via apertures 112. For example, cooling fluid may travel through fluid through holes 152, channels 108, and enter apertures 112. The cooling fluid may extract thermal energy from fluidic die 104 and may carry the extracted thermal energy through apertures 112, channels 108, and fluid through holes 152.

With the foregoing in mind, an example fluidic device (e.g., device 100 in FIG. 1B) may include a fluidic die (e.g., fluidic die 104), a unitary molded structure (e.g., molded structure 102), and a fluidic fan-out structure (e.g., fluidic fan-out structure 150). The unitary molded structure may comprise thermo-electric traces (e.g., traces 106) and fluidic channels (e.g., channels 108). The unitary molded structure may be coupled to the fluidic die. A first dimension of the fluidic channels may be between ten μm to two hundred μm, or less. The fluidic fan-out structure may also be coupled to the unitary molded structure. The fluidic die, the molded structure, and the fluidic fan-out structure may be arranged such that a first fluidic channel of the fluidic channels is in fluid communication with an aperture (e.g., of apertures 112) of the fluidic die at a first extremity and to a fluid through hole (e.g., of fluid through holes 152) of the fluidic fan-out structure at a second extremity (e.g., as illustrated in FIG. 1B).

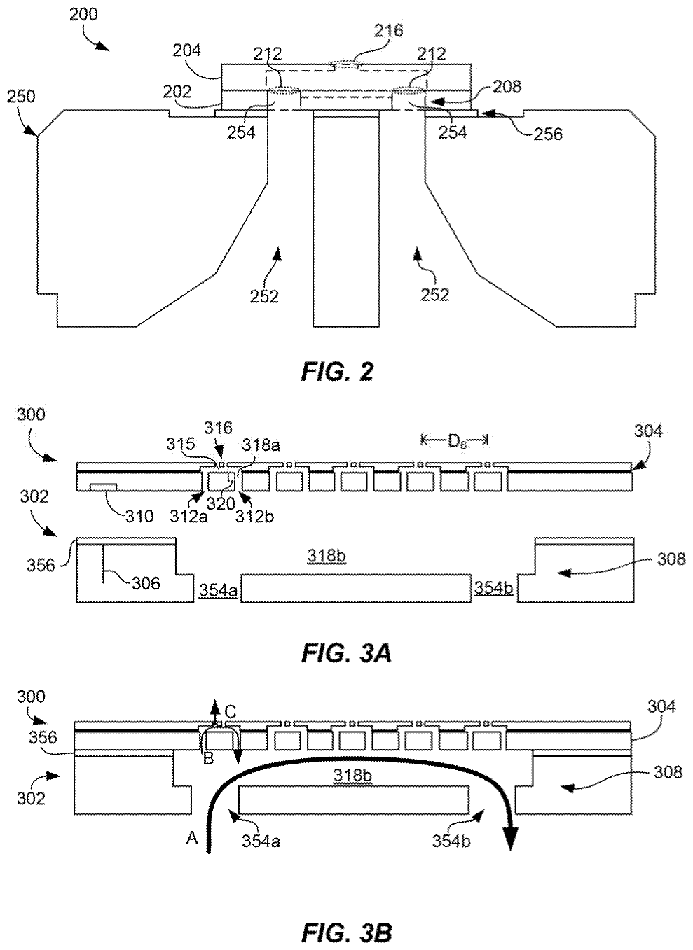

Turning to FIG. 2, an example device 200 is illustrated, in this case as a fluid ejection device. At this point, it is noted that the present disclosure adopts element numbering that indicate similar elements and/or components (e.g., X00: 100, 200, 300, etc. may be similar in structure and/or operation; X02: 102, 202, 302, etc. may be similar in structure and/or operation, etc.). For example, molded structure 202 in FIG. 2 may be similar to molded structure 102 in FIG. 1. Of course, in some cases, while structure and/or operation of similar elements and/or components may be similar across illustrated implementations, there may nevertheless be differences. As such, indications of similar elements and/or components are not intended to be done in a limiting sense (e.g., limiting structure and/or components in subsequent figures to the structure and/or components of preceding elements, and vice versa) unless explicitly stated. For example, the structure (e.g., particular arrangement, shape, materials, etc.) of channels 208 as discussed in relation to FIG. 2 is not intended to limit the structure of channels illustrated in other figures. Similarly, the operation of channels 208 as discussed in relation to FIG. 2 is also not intended to limit the operation of channels illustrated in other figures. For instance, while the dimensions of channels 208 in FIG. 2 may apply to an implementation of a device illustrated in another figure (e.g., FIGS. 3A and 3B), the similar elements in other figures may also support other implementations in which the dimensions may be different.

Fluid ejection device 200 of FIG. 2 shows a fluidic die 204 coupled to a molded structure 202 at a first surface (e.g., the surface corresponding to apertures 212). A fluidic fan-out structure 250 is also coupled to molded structure 202, but at a second surface (e.g., a different surface as compared to the first surface). Adhesive layers mays be used to couple fluidic die 204, molded structure 202, and fluidic fan-out structure 250 together. For instance, an example adhesive layer 256 is shown between fluidic die 204 and fluidic fan-out structure 250. Adhesive layer 256 may comprise any adhesive substance (e.g., tape, conductive adhesive compounds, epoxy, silicone, acrylic adhesives, etc.) suitable to provide support for respective components of device 200. In some cases, there may be a desire to select an adhesive compound that is capable of withstanding exposure to fluids of different pH levels. For instance, some printing fluids may have characteristics that may attack and/or weaken adhesives. There may be a desire, such to achieve a device 200 of a desired smaller dimension, that adhesive layer 256 be relatively thin, such as being less than or equal to 50 μm.

As should be apparent, fluidic die 204, molded structure 202, and fluidic fan-out structure 250 may be arranged such that a fan-out fluid through hole 252 is in fluid communication with one extremity of channel 208 (e.g., the lower dotted portion of molded fluid feed slot 254), and further that an aperture 212 is in fluid communication with another extremity of channel 208 (e.g., the upper portion of molded fluid feed slot 254 within the oval of aperture 212).

In operation, a fluid, such as a printing fluid, may be transmitted through a fan-out fluid through hole 252 (e.g., the left through hole 252 in FIG. 2), such as from a fluid source. In one implementation, an apparatus in which device 200 is arranged may use pumps and/or valves to cause the fluid to move into through holes 252. The fluid may travel into channels 208 of molded structure 202 via molded fluid feed slots 254. The fluid may continue through an aperture 212 (e.g., the left aperture 212) of fluidic die 204. A portion of the fluid may then be ejected through nozzle 216.

Residual fluids may recirculate through the system by exiting fluidic die 204 through another aperture 212 (e.g., the right aperture 212), another molded fluid feed slot 254 (e.g., the right fluid feed slot 254), and another fluid through hole 252 (e.g., the right through hole 252) and on to other components of the apparatus.

In the next drawings, FIGS. 3A and 3B, a particular example context of fluid ejection devices, will be discussed in order to illustrate how claimed subject matter may be of interest to overcoming the challenges and complexities encountered as fluid ejection devices decrease in size and/or density of fluid ejection nozzles increases. Of course, it is to be understood that this description is provided to illustrate potential benefits of claimed subject matter and is not to be taken in a limiting sense.

FIGS. 3A and 3B illustrate an example fluid device 300 comprising a molded structure 302 and a fluidic die 304. FIG. 3A is an exploded view, showing fluidic die 304 separated from molded structure 302, while FIG. 3B shows fluidic die 304 coupled to molded structure 302, such as using an adhesive layer 356. In some cases, adhesive layer 356 may comprise a conductive adhesive layer. As illustrated, molded structure 302 includes a number of channels 308, similar to as described, above. For example, channels 308 may comprise fluid feed slots 354a and 354b, and a recirculation channel 318b. Fluids may enter fluid feed slots 354a and/or 354b of channels 308 (e.g., from a fluid source) and towards apertures 312a and 312b, as shall be discussed hereinafter.

As shown in FIG. 3A, molded structure 302 also includes molded thermo-electric traces 306. As noted above, it may be possible, using the approach described herein, to mold both thermo-electric traces and form channels 308 (e.g., fluid channels) in a unitary structure, molded structure 302. This may be of interest, such as to reduce a dependence on external thermo-electric connections (e.g., traces or wires) outside of fluidic die 304 and molded structure 302. It is noted that FIG. 3B does not illustrate thermo-electric traces 306 or thermo-electric contacts 310, in order to focus on other aspects of the device, however, this is not done in a limiting sense.

Fluidic die 304 includes a number of elements that are similar to those already discussed in relation to FIGS. 1 and 2. For instance, fluidic die 304 includes thermo-electric contacts 310 and apertures 312. Thermo-electric contacts 310 may enable operation of fluidic die 304, such as transmitting current pulses to ejection devices (e.g., resistors, piezo elements, etc.) to cause ejection of printing fluid. Thermo-electric contacts 310 may also enable dissipation of thermal energy, such as via thermo-electric traces 306. And apertures 312 may provide fluid communication toward nozzles 316. For instance, printing fluid may enter ejection chambers 315 of fluidic die 304 through apertures 312. The printing fluid may be ejected via nozzles 316 from ejection chambers 315, such as in response to heat generated at a resistive element. In some cases, fluidic die 304 may include recirculation channels 318a and 318b to transmit printing fluid away from ejection chambers 315. In some implementations, printing fluid may be caused to circulate by pumps or other fluid flow-inducing components. For instance, recirculation components 320 illustrate example elements that may cause fluid to travel from ejection chamber 315 through recirculation channel 318a and towards recirculation channel 318b and molded fluid feed slot 354.

Turning, for instance, to FIG. 38, an arrow ‘A’ shows one fluid recirculation path in which fluid enters molded fluid feed slot 354a, travels through recirculation channel 318b, and exits through molded fluid feed slot 354b. In some implementations, there may be another (or an alternative) recirculation path as shown by arrow ‘B.’ As described above, fluid may enter ejection chamber 315 via an aperture 312a and may recirculate, such as in response to operation of recirculation component 320 and exit through aperture 312b. A portion of fluid circulating through the path illustrated by arrow A, may be pulled into the path illustrated by arrow B, such as in response to fluidic pressure caused by activation of ejection elements, such as resistive elements in the case of thermal ejection devices, or piezo-elements, such as in the case of piezoelectric inkjet devices. It is noted that while a single circulation path (and components thereof) is shown in FIGS. 3A and 3B, this is merely done to simplify the discussion. Indeed, similar fluid circulation paths and fluid ejection components may be arranged at other locations of an array of fluid ejection chambers, etc.

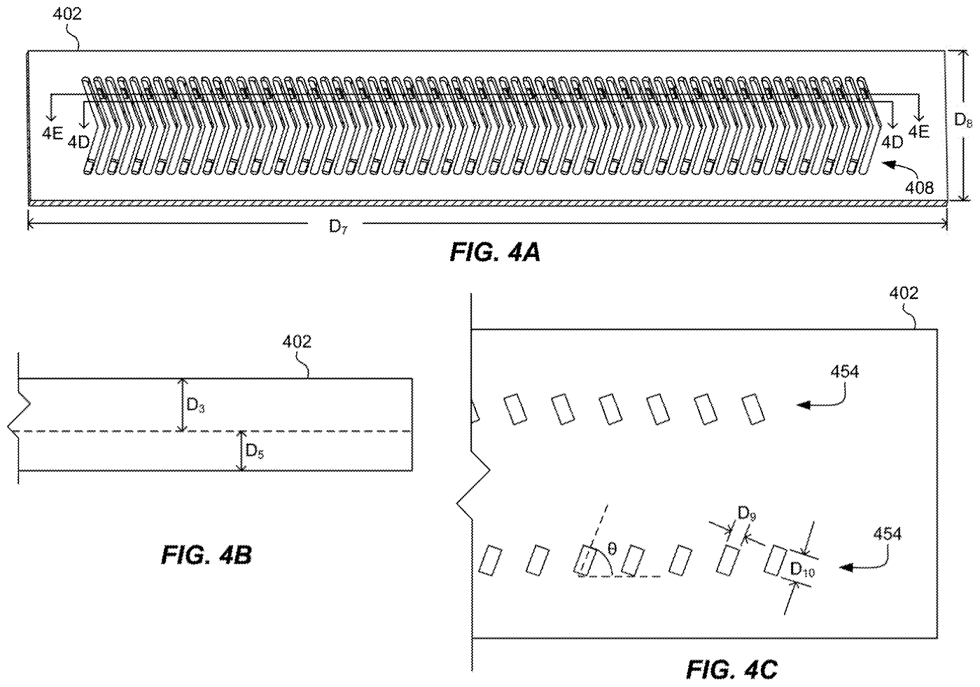

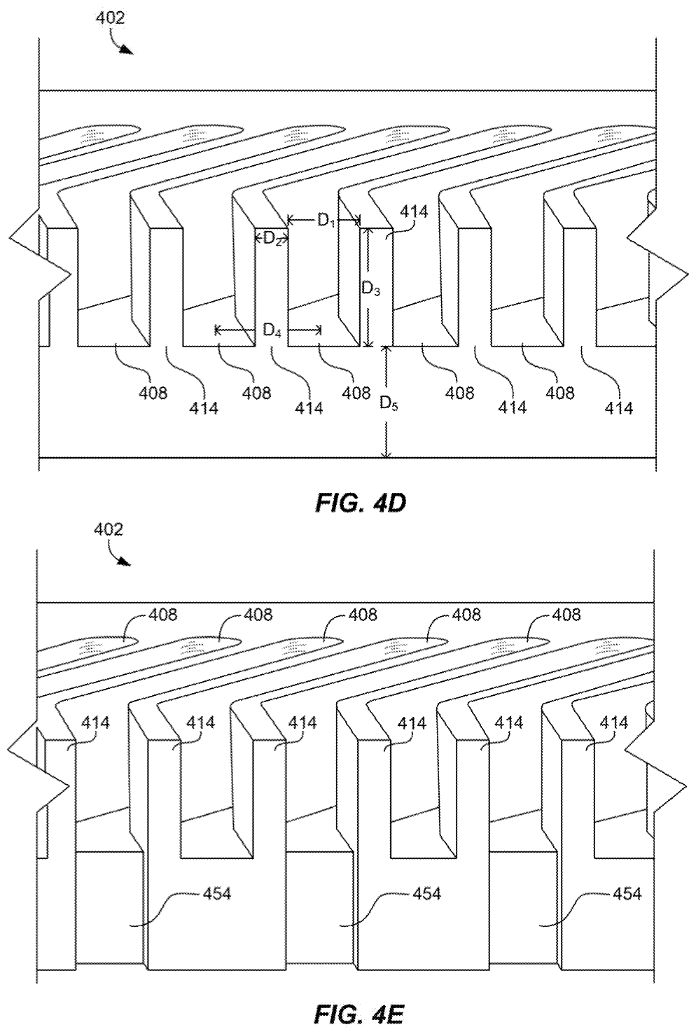

FIG. 3A also illustrates nozzles 316 of fluidic die 304, via which printing fluids may be ejected. D is shown as a nozzle-to-nozzle spacing, also referred to as a nozzle-to-nozzle pitch. In some implementations, D₆ may be on the order of approximately ninety μm and five hundred μm, or less, by way of example. Further dimensions shall be discussed in greater detail hereinafter with reference to FIGS. 4A-4E.

With the foregoing in mind, it should be apparent that in one implementation, an example fluidic ejection device (e.g., device 300) may be such that the fluidic die (e.g., fluidic die 304) comprises ejection chambers (e.g., ejection chamber 315) in fluid communication with fluidic channels (e.g., channels 308) of the molded structure (e.g., molded structure 302) and ejection nozzles (e.g., nozzles 316) of the fluidic die. The fluidic die, the molded structure, and the fluidic fan-out structure (e.g., fluidic fan-out structure 250 of FIG. 2) may be arranged to enable recirculation of fluid through the ejection chambers, apertures of the fluidic die, fluidic channels of the molded structure, and fluidic fan-out through holes of the fluidic fan-out structure.

In another implementation, an example fluidic ejection device (e.g., device 300) may comprise a fluidic die (e.g., fluidic die 304) attached to an epoxy molding compound (EMC) fluidic and electrical chiclet (e.g., molded structure 302). A fluidic circulation path (e.g., fluid circulation path defined by arrow A) defined through microfluidic channels (e.g., channels 308) of the EMC fluidic and electrical chiclet and apertures of the fluidic die. The device may also comprise a thin adhesive compound layer (e.g., adhesive layer 356) between the fluidic die and the EMC fluidic and electrical chiclet. An electrical communication path may also be defined between electrical contacts (thermo-electric contacts 310) of the fluidic die and electrical traces (e.g., thermo-electric traces 306) of the EMC fluidic and electrical chiclet. The microfluidic channels may have a width of between ten μm and fifty μm and a height of between one hundred μm and four hundred μm.

Turning to FIGS. 4A-4E, various aspects of a molded structure 402 are illustrated, such as from different perspectives. FIGS. 4A-4E are directed to an implementation of molded structure 402 in which fluid channels 408 are arranged in a chevron-like array. FIG. 4B is a side view of molded structure 402, illustrating different dimensions of portions thereof. FIG. 4C illustrates a “bottom” portion of molded structure 402 from which perspective, only the molded fluid feed slots 454 are visible (but not other portions of fluid channels 408). FIGS. 4D and 4E are cross-sectional views, from perspectives illustrated by lines 4D-4D and 4E-4E drawn in FIG. 4A. The 4D-4D cross-sectional view cuts across portions of fluid channels 408, which may be used for fluid circulation (e.g., recirculation channel 318b of FIG. 3B).

Starting with FIG. 4D, a number of channels 408, are illustrated in a close-up view. And in FIG. 4E, the perspective from the line 4E-4E cuts through molded fluid feed slots 454, illustrating a slightly different cross-sectional perspective of molded structure 402.

Channels 408 may be separated by a number of separation structures 414. Channels 408 may be arranged within molded structure 402 to correspond to (e.g., be in fluid communication with) apertures of a fluidic die (e.g., apertures 112 of fluidic die 104).

FIG. 4D illustrates a number of example channel dimensions, D₁-D₅. It is noted that FIG. 4D illustrates a particular form of channels, but other implementations, such as in which channels 408 are cylindrical, are also contemplated. Those of skill in the art will appreciate that rather than describing the width, length, and/or depth of a side, in an implementation in which channels 408 are cylinders, the width and length may instead represent a diameter, etc. Returning to FIG. 4D, a width of channels 408 is illustrated as D₁. In one example, D₁ may correspond to approximately five to ten μm. As noted above, traditional fabrication and machining techniques may be unable to achieve channel widths of such small sizes. In another example, D₁ may be approximately fifteen to twenty μm in width. Of course, such techniques enable fabrication of wider channels, such as on the order of one hundred, two hundred, three hundred, four hundred, five hundred, or more μm. Thus, in some cases, such as in some claims, a range of ten to two hundred μm in one dimension may be used as a channel dimension of interest for some contexts. For instance, in the context of a fluid ejection device (e.g., a printing device), the range of ten to two hundred μm in width may be of interest. Of course, in other contexts, the ranges may be smaller or larger. For example, in the context of a biomedical device for testing red blood cells, which can have diameters of six to eight μm, there may be a desire for channel dimensions on the order of ten to twenty μm. Furthermore, there may be implementations for which channels (e.g., channels 208) may be of varying dimensions. Again, in the context of biomedical diagnostic devices, a first subset of channels may have a first width, corresponding to a first fluid or test, and a second subset of channels may have a second width, corresponding to a second fluid or test, etc.

In some cases, there may be a correspondence between the width of channels 408 (e.g., D₁) and a height of channels 408 (e.g., D₃, see also, FIG. 4B). For example, in one case, D₁ may be approximately twenty μm and D₃ may be approximately one hundred μm. In another case, D₁ may be approximately thirty μm and D₃ may be approximately two hundred μm. Etc. The different correspondences between dimensions may be based on materials selected (e.g., some materials may call for additional thickness for structural soundness), use cases (e.g., as noted above with the example of red blood cells, some dimensions may be dictated by context in which a device is to be used), fabrication constraints (e.g., as a width of sacrificial materials decreases, it may be more challenging to maintain a sacrificial material height, etc.), etc.

Another dimension of channels may be a width of separation structures 414, represented as D₂. Similar to the dimensions, D₁ and D₃, the width of separation structures 414 may depend on the context in which molded structure 402 is to be used, the materials used to form molded structure 402, etc. In one example, D₂ may comprise between fifty μm and one hundred μm. For instance, in the context of a fluid ejection device, there may be a desire to provide a denser arrangement of fluid ejection nozzles. Thus, achieving a width D₂ of approximately ninety μm, may be of interest in one case. In other examples, different dimensions for D₂ may be of interest, such as greater or smaller than ninety μm. For example, a different molded structure 402 may have D₂ of approximately thirty μm.

Next, D₄ represents a channel-to-channel dimension and may be between one hundred μm and five hundred μm in one implementation. Of course, D₄ will depend on dimensions D₁ and D₂. Indeed, in some cases, D₄ will be the sum of D₁ and D₂. Therefore, in an implementation in which D₁ is approximately 20 μm and D₂ is approximately 90 μm, D₄ will be approximately 110 μm.

In the context of an example fluid ejection device, D₄ may correspond to a nozzle-to-nozzle spacing. Of course, there may be differences between D₄ and nozzle-to-nozzle spacing based, for instance, on nozzle placement with relation to a firing chamber, a particular nozzle architecture (e.g., in some cases, nozzles may be offset with respect to neighboring nozzles), etc. For example, as was described in relation to FIG. 36, which describes a fluidic die with a recirculation path, a nozzle may not be in fluid communication with each channel 408. For instance, a first channel 408 may correspond to a fluid path for transmitting fluid towards a fluidic die and a neighboring channel 408 may correspond to a fluid path for transmitting fluid away from the fluidic die.

D₅ is yet another dimension of example molded structure 402 that is shown in both FIGS. 4B and 4D. Again, dimensions for D₅ may depend on the intended use for molded structure 402 and materials making up molded structure 402. In some uses, for instance, there may be a desire for that D₅ be thicker than D₃ in order to provide structural support to molded structure 402. However, in other cases, molded structure 402 may be mounted on other components which may provide structural support, and as such, the D₅ can be thinner than D₃. For example, in the case of a fluid ejection device in which D₃ is approximately one hundred μm, D₅ may be approximately fifty μm.

As should be apparent, the different dimensions of different portions of molded structure 402 may vary according to different needs. However, as already discussed, the process of achieving small dimensions—particularly, D₁, D₂, and D₄—within a molded structure may present challenges and complexities that traditional fabrication and machining approaches may not be able to overcome. Consequently, the approaches and methods described herein—such as using sacrificial traces to be removed from molded structures—may be of interest in a variety of different contexts.

Turning back to FIGS. 4A-4C to discuss dimensions, D₇-D₁₀, in one implementation, D₇ of molded structure 402 may be in a range of five mm to twenty-five mm, or less. And De may be in a range of one to three mm, or less. Again, the approach described herein supports sizes both smaller and larger than these example dimensions. And D₅ and D₁₀ illustrate example dimensions of molded fluid feed slots 454. In one implementation, D₉ may correspond to D₁ (e.g., a width of molded fluid feed slots 454 may be approximately the same as a width of fluid channels 408). For example, D₉ may be between five and two hundred μm. D₁₀ may be larger or smaller than D₉, according to a particular context in which molded structure 402 is used. For instance, in the context of printing fluid ejection devices, D₁₀ may be large enough to allow adequate flow of printing fluid to an ejection chamber (e.g., such as not to starve the chamber of printing fluid). But in the context of a biomedical fluidic die, there may be a desire to constrain D₁₀ to allow desired particles and/or a certain volume of fluids to travel into the fluidic die. In one implementation, D₁₀ may be ten and four hundred μm. And the angle, θ, may correspond to approximately 70°, such as 71.6° in one example.

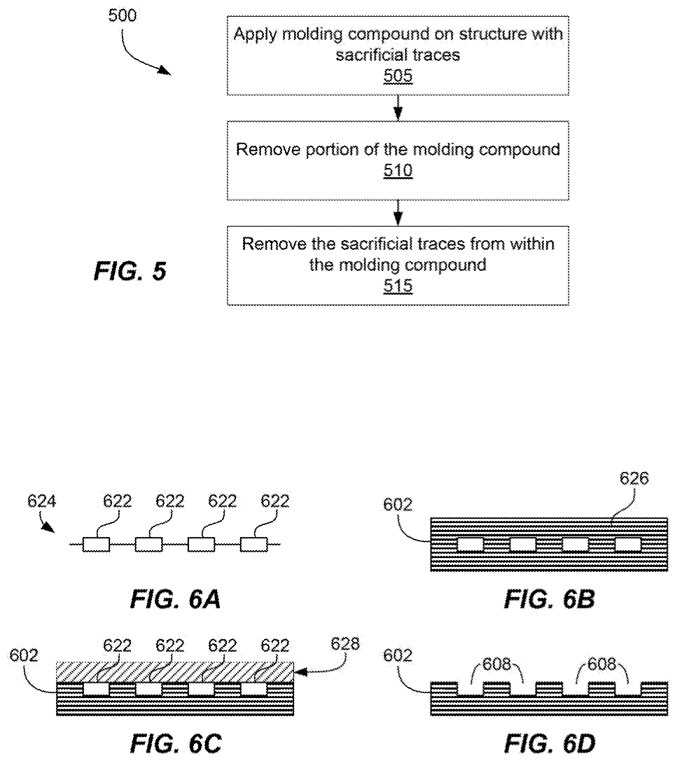

FIG. 5 illustrates an example method 500 of forming a molded structure (e.g., molded structure 302 in FIG. 3B). Reference will be made to FIGS. 6A-6D while describing method 500.

At 505, a molding compound is applied on or over a structure with sacrificial traces. The resulting structure may correspond to a molded package. FIG. 6A illustrates a structure 624 including example sacrificial traces 622. In one implementation, structure 624 may be a lead frame structure. In another, structure 624 may comprise a support layer upon which sacrificial traces are arranged (e.g., metal build up). Sacrificial traces may include Cu or Ni by way of non-limiting example. Sacrificial traces 622 may be within a range of approximately ten μm to approximately two hundred μm, or less, in one dimension. And FIG. 6B illustrates a molding compound 626 arranged on or over structure 624 from FIG. 6A, forming a molded structure 602. As noted above, molding compound 626 may be in a number of forms, for example, a low CTE material, such as EMC.

Returning to method 500, at 510, a portion of the molding compound is removed. FIG. 6C illustrates a removed portion 628 of molding compound 626 (from FIG. 6B). The removal of a portion of the molding compound may expose a portion of sacrificial traces 622. In one implementation, removal of the portion of molding compound may be done by surface grinding.

With sacrificial traces exposed, at 515 of method 500, the sacrificial traces may be removed from within the molding compound. For example, an etching process may be used, such as using a chemical etch to remove the sacrificial traces 622. FIG. 6D illustrates molded structure 602 after the removal of sacrificial traces 622 to yield channels 608.

Thus, in one implementation, an example method (e.g., method 500) of forming a fluidic device may comprise applying a molding compound (e.g., molding compound 626) on a structure (e.g., structure 624) comprising sacrificial traces (e.g., sacrificial traces 622) to form a molded package. As noted, in some cases, the sacrificial traces may comprise copper (Cu). The method may also comprise removing a portion of the molded package (e.g., portion 628). At times, the removing the portion of the molded package may comprise surface grinding a surface of the molded package. And the method may also comprise removing the sacrificial traces to form embedded fluidic channels (e.g., fluid channels 608) within the molded package. In some implementations, removing the sacrificial traces may comprise etching the Cu-based sacrificial traces.

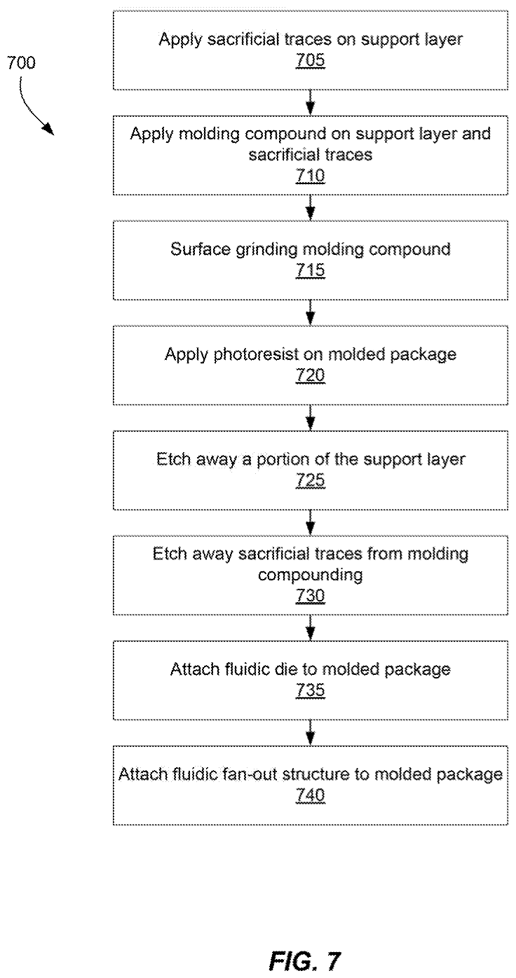

Moving on to FIG. 7, an example method 700 for forming a molded structure (e.g., molded structure 302) with channels formed by removing sacrificial traces is illustrated. In this example, sacrificial traces are built up on or over a support component (as opposed to using a lead frame, for example).

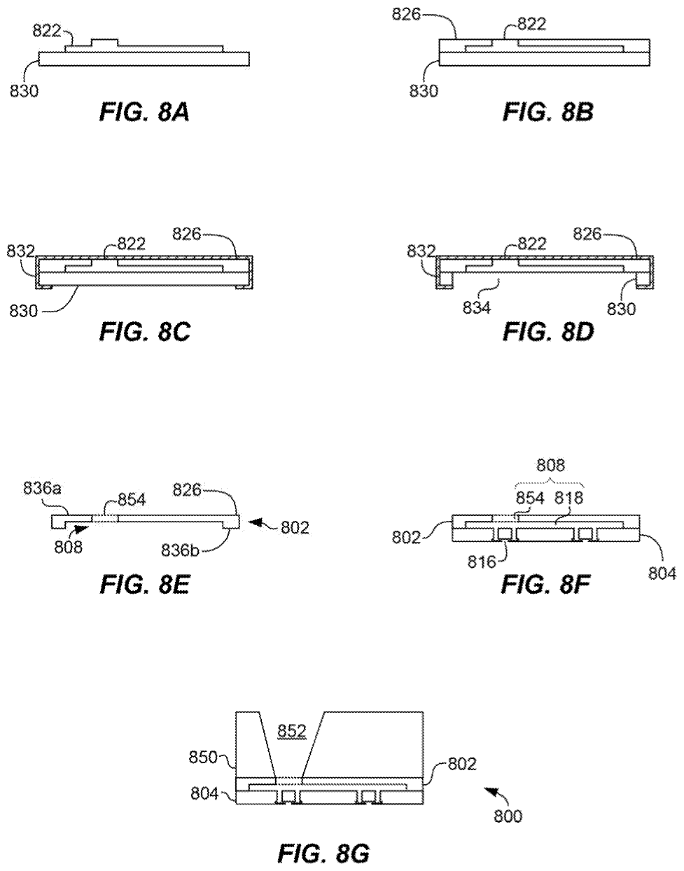

At 705, a structure comprising sacrificial traces (e.g., sacrificial traces 822 in FIG. 8A) is deposited on or over a support layer (e.g., support layer 830 in FIG. 8A). Examples of support layer 830 may include metals and metalloids (e.g., Cu-coated steel plate). Sacrificial traces 822 may be built up by dry film lamination over Cu-coated steel plate, laser direct writing to define sacrificial trace patterns, electroplating to deposit sacrificial metal, and then stripping the dry film resist. Of course, as noted, in other implementations, rather than building up sacrificial traces, as discussed in relation to 705, the structure comprising sacrificial traces (e.g., structure 624 in FIG. 6A) may comprise using a lead frame structure upon which the molding compound may be applied.

At 710, a molding compound (e.g., molding compound 826 in FIG. 8B) is applied on or over the support layer and the sacrificial traces from block 705. FIG. 8B illustrates molding compound 826 arranged on or over top of support layer 830 and sacrificial traces 822. Of course, other molding arrangements are contemplated by claimed subject matter. Molding compound 826 may comprise a low CTE material, such as an EMC, as described above.

At 715, a portion of the molding compound is removed. Removal of a portion of the molding compound is not shown in FIGS. 8A-8G but may be understood by reference to FIGS. 6B and 6C and associated description. FIG. 88 shows an upper surface of sacrificial traces 822 as being coplanar with an upper surface of molding compound 826. As noted, above, removal of molding compound 826 may be performed by surface grinding.

At 720, photoresist (e.g., photoresist layer 832 in FIG. 8C) is applied to the chip package. As shown in FIG. 8C, photoresist layer 832 may not completely cover the chip package. Indeed, a portion of support layer 830 may remain uncovered or exposed, so that a portion of support layer can be removed. Photoresist layer 832 may protect thermo-electric traces and other components for which there may be a desire to protect against removal, such as at block 725.

At 725, a portion of the support layer is etched. FIG. 8D illustrates a removed portion 834 of support layer 830. For example, in the context of a fluid ejection device, a fluidic die (e.g., fluidic die 304 of FIG. 3) may be attached to molded structure 802 within the space from which a portion 834 of support layer 830 was removed.

At 730, the sacrificial traces are removed from the molding compound. The photoresist layer 832 may also be removed, leaving a finished molded structure 802, as illustrated in FIG. 8E. FIG. 8E illustrates channels 808, including a molded fluid feed slot 854, arranged within molding compound 826. The process of removing sacrificial traces 822 may include the use of a chemical etch selected to remove the sacrificial material but leave molding compound 826. The remaining molding compound 826, channels 808, and support layer 830 may be referred to as a chip package (e.g., an EMC chip package).

At 735, a fluidic die (e.g., fluidic die 804) may be attached to the molded package, as illustrated in FIG. 8F. The fluidic die may have structures and may operate similarly to those examples discussed, above (e.g., fluidic die 304), such as a channel 808, molded fluid feed slot 854, and recirculation channel 818. The fluidic die may be attached to a first surface (e.g., surface 836b) of the molded package, such as using a thin adhesive layer, as discussed above.

At 740, a fluidic fan-out structure (e.g., fluidic fan-out structure 850) may be attached to the molded package, as illustrated in FIG. 8G. The fluidic fan-out structure may have a fan-out fluid through hole 852 in fluid communication with molded channels 808 and may form a device 800.

With the foregoing in mind, another example method may include parts of example methods discussed, above. Additionally, it may include applying a photoresist layer (e.g., photoresist layer 832) on the molded package and leaving a photoresist window in the photoresist layer in relation to the support layer. Subsequently, a portion of the support layer corresponding to the photoresist window may be etched away. The example method may also include attaching a fluidic die (e.g., fluidic die 804 having an example nozzle 816) to a first surface 836b of the molded package using a thin adhesive compound layer such that apertures of the fluidic die correspond to embedded fluidic channels of the molded package. The method may also include attaching a fluidic fan-out structure (e.g., fluidic fan-out structure 850) to a second surface (e.g., surface 836a) of the molded package such that fluidic fan-out through holes (e.g., fan-out fluid through holes) of the fluidic fan-out structure correspond to the embedded fluidic channels of the molded package, and further such that fluid paths are defined through the fan-out fluid through holes, embedded fluidic channels, and apertures.

As noted, in some cases, the example method of applying the molding compound on the structure comprising sacrificial traces may also comprise applying the molding compound on a structure comprising electrical traces. And it may also include applying a photoresist layer to protect the electrical traces while the sacrificial traces are removed.

As should be apparent from the above, the present description provides an approach for forming channels within a molded structure using sacrificial materials, such as to enable recirculation of fluids between a fluidic die and channels of the molded structure.

In the present description, in a particular context of usage, such as a situation in which tangible components (and/or similarly, tangible materials) are being discussed, a distinction exists between being “on” and being “over.” As an example, deposition of a substance “on” a substrate refers to a deposition involving direct physical and tangible contact without an intermediary, such as an intermediary substance (e.g., an intermediary substance formed during an intervening process operation), between the substance deposited and the substrate in this latter example; nonetheless, deposition “over” a substrate, while understood to potentially include deposition “on” a substrate (since being “on” may also accurately be described as being “over”), is understood to include a situation in which intermediaries, such as intermediary substances, are present between the substance deposited and the substrate so that the substance deposited is not necessarily in direct physical and tangible contact with the substrate.

A similar distinction is made in an appropriate particular context of usage, such as in which tangible materials and/or tangible components are discussed, between being “beneath” and being “under.” While “beneath,” in such a particular context of usage, is intended to necessarily imply physical and tangible contact (similar to “on,” as just described), “under” potentially includes a situation in which there is direct physical and tangible contact but does not necessarily imply direct physical and tangible contact, such as if intermediaries, such as intermediary substances, are present. Thus, “on” is understood to mean “immediately over” and “beneath” is understood to mean “immediately under.”

It is likewise appreciated that terms such as “over” and “under” are understood in a similar manner, as previously mentioned. These terms may be used to facilitate discussion but are not intended to necessarily restrict scope of claimed subject matter. For example, the term “over,” as an example, is not meant to suggest that claim scope is limited to situations in which an implementation is right side up, such as in comparison with the implementation being upside down, for example. An example includes a molded structure (e.g., molded structure 202 in FIG. 2), as one illustration, in which, for example, orientation at various times (e.g., during fabrication) may not necessarily correspond to orientation of a final product. Thus, if an object, as an example, is within applicable claim scope in a particular orientation, such as upside down, as one example, likewise, it is intended that the latter also be interpreted to be included within applicable claim scope in another orientation, such as right side up, again, as an example, and vice-versa, even if applicable literal claim language has the potential to be interpreted otherwise. Of course, again, as always has been the case in the specification of a patent application, particular context of description and/or usage provides helpful guidance regarding reasonable inferences to be drawn.

Unless otherwise indicated, in the context of the present disclosure, the term “or” if used to associate a list, such as A. B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. Furthermore, the terms “first,” “second” “third,” and the like are used to distinguish different aspects, such as different components, as one example, rather than supplying a numerical limit or suggesting a particular order, unless expressly indicated otherwise. Likewise, the term “based on” and/or similar terms are understood as not necessarily intending to convey an exhaustive list of factors, but to allow for existence of additional factors not necessarily expressly described.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A fluidic device comprising:
a fluidic die;
a unitary molded structure comprising electrical traces and fluidic channels, the molded structure coupled to the fluidic die, wherein a first dimension of the fluidic channels is between ten μm to two hundred μm, or less; and
a fluidic fan-out structure coupled to the molded structure;
the fluidic die, the molded structure, and the fluidic fan-out structure arranged such that a first fluidic channel of the fluidic channels is in fluid communication with an aperture of the fluidic die at a first extremity and to a fan-out fluid through hole of the fluidic fan-out structure at a second extremity.

2. The fluidic device of claim 1, wherein the molded structure comprises a low coefficient of thermal expansion (CTE) material.

3. The fluidic device of claim 2, wherein the low CTE material comprises an epoxy molding compound (EMC).

4. The fluidic device of claim 1, wherein the fluidic die comprises ejection chambers in fluid communication with the fluidic channels of the molded structure and ejection nozzles of the fluidic die, and further wherein the fluidic die, the molded structure, and the fluidic fan-out structure are arranged to enable recirculation of fluid through the ejection chambers, apertures of the fluidic die, fluidic channels of the molded structure, and fluidic fan-out through holes of the fluidic fan-out structure.

5. The fluidic device of claim 1, wherein the fluidic channels of the molded structure have a second dimension corresponding to fluid channel height, the first dimension corresponding to a fluid channel width, and further wherein the second dimension is between one hundred μm and five hundred μm.

6. The fluidic device of claim 5, wherein a channel-to-channel distance is between ten μm and two hundred μm.

7. The fluidic device of claim 1, wherein the fluidic die is attached directly to the molded structure using a thin adhesive compound layer.

8. The fluidic device of claim 7, wherein the thin adhesive compound layer is less than or equal to 50 μm.

9. A method of forming a fluidic device, the method comprising:
applying a molding compound on a structure comprising sacrificial traces to form a molded package;
removing a portion of the molded package; and
removing the sacrificial traces to form embedded fluidic channels within the molded package.

10. The method of claim 9 comprising:
applying the sacrificial traces to a support layer, the sacrificial traces comprising copper (Cu);
wherein the removing the portion of the molded package comprises surface grinding a surface of the molded package;
and further wherein removing the sacrificial traces comprises etching the Cu-based sacrificial traces.

11. The method of claim 10 comprising:
applying a photoresist layer on the molded package and leaving a photoresist window in the photoresist layer in relation to the support layer; and
etching away a portion of the support layer corresponding to the photoresist window.

12. The method of claim 9 comprising:
attaching a fluidic die to a first surface of the molded package using a thin adhesive compound layer, apertures of the fluidic die corresponding to the embedded fluidic channels of the molded package; and
attaching a fluidic fan-out structure to a second surface of the molded package, fan-out fluid through holes of the fluidic fan-out structure corresponding to the embedded fluidic channels of the molded package, fluid paths being defined through the fan-out fluid through holes, embedded fluidic channels, and apertures.

13. The method of claim 9, wherein the applying the molding compound on the structure comprising sacrificial traces comprises applying the molding compound on a lead frame structure.

14. The method of claim 9, wherein the applying the molding compound on the structure comprising sacrificial traces comprises applying the molding compound on a structure comprising thermo-electric traces, the method further comprising:
applying a photoresist layer to protect the thermo-electric traces while the sacrificial traces are removed.

15. A fluidic ejection device comprising a fluidic die attached to an epoxy molding compound (EMC) fluidic and electrical chiclet, the fluidic ejection device comprising:
a fluidic circulation path defined through microfluidic channels of the EMC fluidic and electrical chiclet and apertures of the fluidic die;
a thin adhesive compound layer between the fluidic die and the EMC fluidic and electrical chiclet; and
an electrical communication path defined between electrical contacts of the fluidic die and electrical traces of the EMC fluidic and electrical chiclet;
wherein the microfluidic channels have a width of between ten μm and fifty μm and a height of between one hundred μm and four hundred μm.
